(19) United States
(12) Patent Application Publication
(10) Pub. No.: US 2007/0019885 A1
(43) Pub. Date: Jan. 25, 2007

(54) Feature based caricaturing

(76) Inventors: David J. Chatting, Ipswich (GB); Jeremy M. Thorne, Ipswich (GB); Mark S. Fendley, Brentwood (GB)

Correspondence Address: NIXON & VANDERHYE, PC, 901 NORTH GLEBE ROAD, 11TH FLOOR, ARLINGTON, VA, 22203, US

(21) Appl. No.: 10/556,459

(22) PCT Filed: Apr. 8, 2004
(86) PCT No.: PCT/GB04/01605

§ 371 Date: Nov. 10, 2005

(30) Foreign Application Priority Data
May 15, 2003 (GB) 03112083

(51) Int. Cl. G06K 9/36

(52) U.S. Cl. 382/289

(57) ABSTRACT

The invention provides a method and system of generating a caricatured image which takes into account facial features, and applies caricaturing to each feature area independently. This is achieved by defining within a reference image predefined feature areas, and then finding corresponding areas in an input image to the reference feature areas. A caricatured image is then generated by taking points within the input image in turn, and determining within which feature area a point lies. A corresponding caricature point can then be found depending upon the feature area in which the point was found to lie.

### TECHNICAL FIELD

The present invention relates to a method and system for generating caricatured images.

### BACKGROUND TO THE INVENTION AND PRIOR ART

Automatic caricaturing methods and systems are already known in the art. Brennan, S. E. in “Caricature Generator: The Dynamic Exaggeration of Faces by Computer.” Leonardo, Vol.18 no.3, pp. 170-178 describes a computational model of caricature which allowed a two dimensional line drawn caricature to be generated from photographs. The user traces over the original image (by placing a set of markers over the image) to generate a veridical line drawing of the subject. An example of such an original image and the resulting veridical line drawing are shown in FIG. 11. Here, an original image as shown in FIG. 11(a) results in a veridical line drawing as shown in FIG. 11(b).

Having obtained the veridical line drawing of the subject, this drawing is then compared with a corresponding line drawing of a “mean” or “prototype” face, by which is meant an average face of a group usually comprising the same race, gender, and colour as the subject. Thus, for the white Caucasian male shown in FIG. 11(a), usually a prototype face of an “average” white Caucasian male would be used. In some circumstances prototype faces from different ethnic groups may be used.

Rowland et al in “Transforming Facial Images in 2 and 3-D”. Imagina 97 —Conferences—ACTES/Proceedings, Feb, Monte Carlo, (1997), pp 159-175 describe how a prototype face may be derived as follows. A prototype can be defined as being a representation of the consistencies across a collection of faces. For example, a prototypical male Caucasian face would contain all that is consistent about Caucasian faces and can be generated by calculating a mean face from a set of Caucasian faces.

To derive the prototypical shape for a group of faces, the delineation data for each face are first “normalised” , making the faces nominally of the same size and orientation. The left and right pupil centres provide convenient landmark points for this process. The first step is to calculate the average left and right eye positions for the whole population. The next step is to apply a uniform translation, scaling, and rotation to the (x, y) positions of all the feature points, thus normalising each face to map the left eye to the average left eye position and the right eye to the average right eye position. This process maintains all the spatial relationships between the features within each face but standardises face size and alignment. It is then possible to calculate the average positions of each remaining template point (after alignment), the resulting data constituting the mean shape for the given population. A line drawing of the resulting “mean” or prototype face can then be obtained. An example line drawing of a mean face is shown in FIG. 6(a).

Once a prototype has been formed for a collection of faces it is possible to generate caricatures by accentuating the difference between an individual face and a relevant prototype. After normalising the feature location data from the prototype to the eye positions of an example face, all feature points on the example face can be shifted away from their counterparts on the prototypical face by a given percentage. This percentage is the amount of caricature and can be thought of as extrapolating a morph between a prototype and the example face. (If the percentage is 100% then the product of the manipulation will be the prototype, if the percentage is 50% then the result will be halfway along the morph between the prototype and the example face, if the percentage is 0% then the example face is returned, if it is −50% then a caricature of the original face is the result. More generally, any percentage less than 0% will result in a caricatured face.

The problem with this approach is that for any face that we wish to caricature we must place markers in the same locations as the feature points defined in the prototype face. This limits the application of this algorithm as it can not be applied to any face model, for instance one derived from a 3D scanner (because models from different sources have different topologies and resolutions).

### SUMMARY OF THE INVENTION

In order to address the above problem, the present invention provides a method of generating a caricatured image which takes into account facial features, and applies caricaturing to each feature area independently. This is achieved by defining within a reference image predefined feature areas, and then finding corresponding areas in an input image to the reference feature areas. A caricatured image is then generated by taking points within the input image in turn, and determining within which feature area a point lies. A corresponding caricature point can then be found depending upon the feature area in which the point was found to lie. This has the effect of applying caricaturing transformations on a feature by feature basis. Moreover, the transformations applied preferably comprise translations and scalings, such that the resulting shape of each feature is not distorted.

In view of the above, according to a first aspect of the invention there is provided a method of generating a caricatured image, comprising the steps of:
receiving an input image to be caricatured;
identifying feature areas on the input image; and
applying respective caricaturing transformations to the identified feature areas in the input image so as to generate a caricatured image comprising the transformed feature areas.

The invention in the first aspect provides the advantage that features of the image are taken account of independently, such that an appropriate caricaturing can be applied to that feature. This alleviates the problems of the prior art techniques wherein features of the input image may be overly distorted by the applied caricaturing, by providing for less distortion over a larger range of caricaturing levels. Additionally, the invention also allows for caricaturing of faces with differing topologies, provided the features of the faces can be identified.

Moreover, by use of the term “image” herein we also intend to cover various facial model formats which can describe faces, such as, for example, MPEG-4 facial description parameter, or virtual models of faces. It will clearly be understood by the skilled man that caricaturing transformations as used by the invention can equally be applied to features within virtual reality models of faces in the same manner as applied to features of facial images. Moreover, a virtual reality model must be displayed as an image in due course in any event, and hence caricaturing of such a model implicitly includes caricaturing of the subsequent image of that model when rendered onto a screen.

Preferably, within a preferred embodiment the method further comprises determining a caricature level defining the amount of caricaturing to be applied to the input image in dependence on the intended size of the caricature image to be generated; and applying the caricaturing transformations in further dependence on the determined caricature level. This allows, for example, for a greater degree of caricaturing to be applied if the image to be generated is smaller. Such an operation may have the effect of helping recognition of the caricatured image by a viewer.

From a second aspect the present invention also provides a caricature generation system, comprising:

an image input means for receiving an input image to be caricatured; and

processing means arranged in use to:
i) identify feature areas on the input image; and
ii) apply respective caricaturing transformations to the identified feature areas in the input image so as to generate a caricatured image comprising the transformed feature areas.

Within the second aspect the same advantages are obtained as described in respect of the first aspect above. Additionally, the same further features may also be incorporated, in embodiments thereof.

From a third aspect the present invention further provides a computer program or suite of computer programs arranged such that when executed by a computer system it/they cause the computer system to operate according to the aforementioned first aspect.

Moreover, from a fourth aspect, there is also provided a computer readable storage medium arranged to store a computer program according to the third aspect of the invention. The computer readable storage medium may be any magnetic, optical, magneto-optical, solid-state, or other storage medium capable of being read by a computer.

### BRIEF DESCRIPTION OF THE DRAWINGS

Further features and advantages of the present invention will become apparent from the following description of embodiments thereof, presented by way of example only, and by reference to the accompanying drawings, wherein like reference numerals refer to like parts, and wherein:

FIG. 1 is an illustration of a general purpose computer system which may form the operating environment of embodiments of the present invention;

FIG. 2 is a system block diagram of the general purpose computer system of FIG. 1;

FIG. 3 is a block diagram of the hard disk of FIG. 2, illustrating the programs stored thereon according to an embodiment of the invention;

FIG. 4 is a flow diagram illustrating the steps performed in an embodiment of the invention;

FIG. 5 is a flow diagram illustrating the steps performed in an embodiment of the invention;

FIG. 6(a) illustrates a line drawing of a prototype face used in an embodiment of the invention;

FIG. 6(b) illustrates how feature areas may be defined on the prototype face in an embodiment of the present invention;

FIG. 7(a) is an example input image in an embodiment of the present invention;

FIG. 7(b) illustrates how automated image processing techniques may be used to find facial features in an embodiment of the present invention;

FIG. 8(a) is an example caricature image generated by an embodiment of the present invention;

FIG. 8(b) is a caricature image generated by a prior art caricaturing algorithm;

FIG. 9(a) is a second example caricature image generated by an embodiment of the present invention;

FIG. 9(b) is a second example caricatured image generated by a prior art caricaturing algorithm;

FIG. 10 illustrates further caricatured images of different sizes generated by an embodiment of the present invention;

FIG. 11(a) illustrates an example input image to an embodiment of the present invention; and

FIG. 11(b) illustrates a veridical line drawing generated from the image of FIG. 11 (a).

### DESCRIPTION OF THE EMBODIMENT

Embodiments of the present invention will now be described, which act to generate line drawing caricature images.

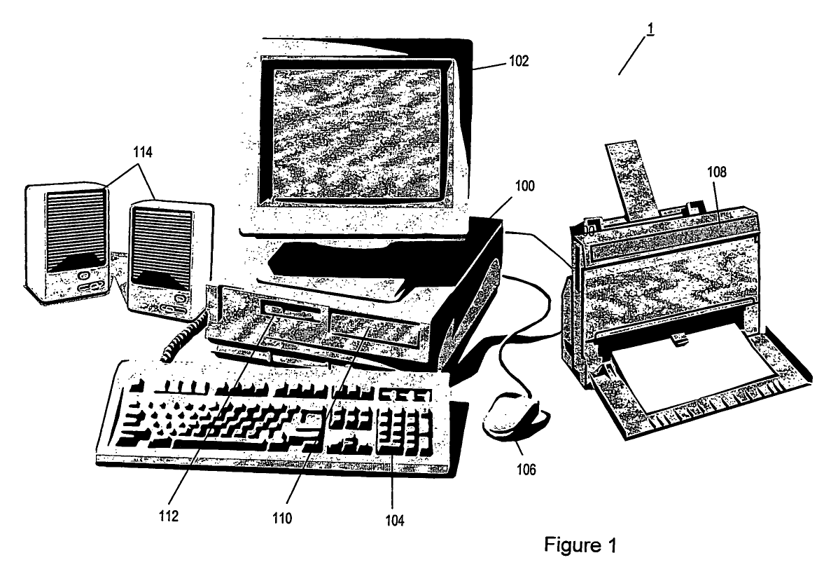

FIG. 1 illustrates a general purpose computer system which provides the operating environment of the embodiments of the present invention. Later, the operation of the invention will be described in the general context of computer executable instructions, such as program modules, being executed by a computer. Such program modules may include processes, programs, objects, components, data structures, data variables, or the like that perform tasks or implement particular abstract data types. Moreover, it should be understood by the intended reader that the invention may be embodied within other computer systems other than those shown in FIG. 1, and in particular hand held devices, notebook computers, main frame computers, mini computers, multi processor systems, distributed systems, etc. Within a distributed computing environment, multiple computer systems may be connected to a communications network and individual program modules of the invention may be distributed amongst the computer systems.

With specific reference to FIG. 1, a general purpose computer system 1 which forms the operating environment of the embodiments of the invention, and which is generally known in the art, comprises a desk-top chassis base unit 100 within which is contained the computer power unit, mother board, hard disk drive or drives, system memory, graphics and sound cards, as well as various input and output interfaces. Furthermore, the chassis also provides a housing for an optical disk drive 110 which is capable of reading from and/or writing to a removable optical disk such as a CD, CDR, CDRW, DVD, or the like. Furthermore, the chassis unit 100 also houses a magnetic floppy disk drive 112 capable of accepting and reading from and/or writing to magnetic floppy disks. The base chassis unit 100 also has provided on the back thereof numerous input and output ports for peripherals such as a monitor 102 used to provide a visual display to the user, a printer 108 which may be used to provide paper copies of computer output, and speakers 114 for producing an audio output. A user may input data and commands to the computer system via a keyboard 104, or a pointing device such as the mouse 106.

It will be appreciated that FIG. 1 illustrates an exemplary embodiment only, and that other configurations of computer systems are possible which can be used with the present invention. In particular, the base chassis unit 100 may be in a tower configuration, or alternatively the computer system 1 may be portable in that it is embodied in a lap-top or note-book configuration. Other configurations such as personal digital assistants or even mobile phones may also be possible.

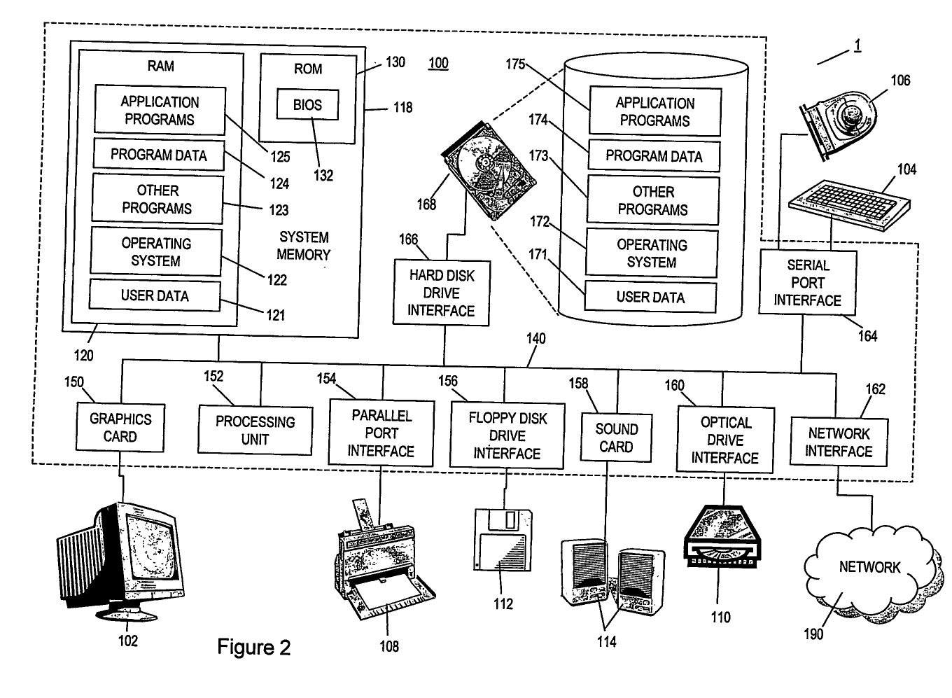

FIG. 2 illustrates a system block diagram of the system components of the computer system 1. Those system components located within the dotted lines are those which would normally be found within the chassis unit 100.

With reference to FIG. 2, the internal components of the computer system 1 include a mother board upon which is mounted system memory 118 which itself comprises random access memory 120, and read only memory 130. In addition, a system bus 140 is provided which couples various system components including the system memory 118 with a processing unit 152. Also coupled to the system bus 140 are a graphics card 150 for providing a video output to the monitor 102; a parallel port interface 154 which provides an input and output interface to the system and in this mbodiment provides a control output to the printer 108; and a floppy disk drive interface 156 which controls the floppy disk drive 112 so as to read data from any floppy disk inserted therein, or to write data thereto. In addition, also coupled to the system bus 140 are a sound card 158 which provides an audio output signal to the speakers 114; an optical drive interface 160 which controls the optical disk drive 110 so as to read data from and write data to a removable optical disk inserted therein; and a serial port interface 164, which, similar to the parallel port interface 154, provides an input and output interface to and from the system. In this case, the serial port interface provides an input port for the keyboard 104, and the pointing device 106, which may be a track ball, mouse, or the like.

Additionally coupled to the system bus 140 is a network interface 162 in the form of a network card or the like arranged to allow the computer system 1 to communicate with other computer systems over a network 190. The network 190 may be a local area network, wide area network, local wireless network, or the like. In particular, IEEE 802.11 wireless LAN networks may be of particular use to allow for mobility of the computer system. The network interface 162 allows the computer system 1 to form logical connections over the network 190 with other computer systems such as servers, routers, or peer-level computers, for the exchange of programs or data.

In addition, there is also provided a hard disk drive interface 166 which is coupled to the system bus 140, and which controls the reading from and writing to of data or programs from or to a hard disk drive 168. All of the hard disk drive 168, optical disks used with the optical drive 110, or floppy disks used with the floppy disk 112 provide non-volatile volatile storage of computer readable instructions, data structures, program modules, and other data for the computer system 1. Although these three specific types of computer readable storage media have been described here, it will be understood by the intended reader that other types of computer readable media which can store data may be used, and in particular magnetic cassettes, flash memory cards, tape storage drives, digital versatile disks, or the like.

Each of the computer readable storage media such as the hard disk drive 168, or any floppy disks or optical disks, may store a variety of programs, program modules, or data. In particular, the hard disk drive 168 in the embodiment particularly stores a number of application programs 175, application program data 174, other programs required by the computer system 1 or the user 173, a computer system operating system 172 such as Microsoft® Windows®, Linux™, Unix™, or the like, as well as user data in the form of files, data structures, or other data 171. The hard disk drive 168 provides non volatile storage of the aforementioned programs and data such that the programs and data can be permanently stored without power.

In order for the computer system 1 to make use of the application programs or data stored on the hard disk drive 168, or other computer readable storage media, the system memory 118 provides the random access memory 120, which provides memory storage for the application programs, program data, other programs, operating systems, and user data, when required by the computer system 1. When these programs and data are loaded in the random access memory 120, a specific portion of the memory 125 will hold the application programs, another portion 124 may hold the program data, a third portion 123 the other programs, a fourth portion 122 the operating system, and a fifth portion 121 may hold the user data. It will be understood by the intended reader that the various programs and data may be moved in and out of the random access memory 120 by the computer system as required. More particularly, where a program or data is not being used by the computer system, then it is likely that it will not be stored in the random access memory 120, but instead will be returned to non-volatile storage on the hard disk 168.

The system memory 118 also provides read only memory 130, which provides memory storage for the basic input and output system (BIOS) containing the basic information and commands to transfer information between the system elements within the computer system 1. The BIOS is essential at system start-up, in order to provide basic information as to how the various system elements communicate with each other and allow for the system to boot-up.

Whilst FIG. 2 illustrates one embodiment of the invention, it will be understood by the skilled man that other peripheral devices may be attached to the computer system, such as, for example, microphones, joysticks, game pads, scanners, digital cameras, or the like. In addition, with respect to the network interface 162, we have previously described how this is preferably a wireless LAN network card, although equally it should also be understood that the computer system I may be provided with a modem attached to either of the serial port interface 164 or the parallel port interface 154, and which is arranged to form logical connections from the computer system 1 to other computers via the public switched telephone network (PSTN).

Where the computer system 1 is used in a network environment, it should further be understood that the application programs, other programs, and other data which may be stored locally in the computer system may also be stored, either alternatively or additionally, on remote computers, and accessed by the computer system 1 by logical onnections formed over the network 190.

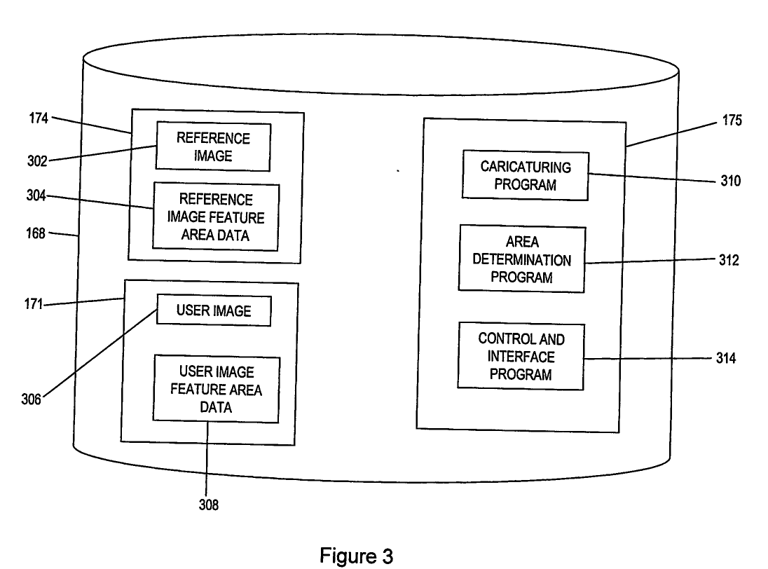

Having described the operating environment for the embodiments of the invention, the individual software programs and data which are required by the embodiments of the invention in order to operate will now be described with respect to FIG. 3.

FIG. 3 illustrates the hard disk 168 of the general purpose computer system illustrated in FIGS. 1 and 2. In particular, the application program area 175 of the hard disk is shown, together with the program data area 174, and the user data area 171.

Stored within the application program area 175 is a caricaturing program 310 which is used by the embodiment of the invention, as well as an area determination program 312, which is also used by the embodiment of the invention. Finally, the embodiment also provides a control and interface program 314 which acts to control the operation of the caricaturing program 310 and the area determination program 312 in order to provide the embodiment. The operation of the caricaturing program 310, area determination program 312, and control and interface program 314 will be described in detail later.

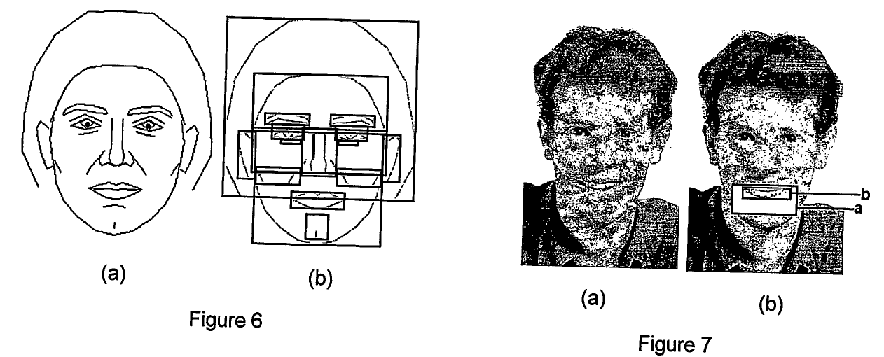

Stored within the program data area 174 of the hard disk is a reference image 302, and reference image feature area data 304. The reference image 302 is an image corresponding to the prototype face image such as is shown in FIG. 6(a). The reference image feature area data 304 is data which defines the reference image feature areas as shown in FIG. 6(b). The feature areas defined in FIG. 6(b) are as follows:

Face outline; nose; mouth; right ear; left ear; right eye; left eye; right eyebrow; left eyebrow; hair outline; forehead; right eyeline; left eyeline; right cheek; left cheek; chin; and jaw.

These features have been chosen such that they represent a reasonably autonomous grouping on the face. Each feature is described by a centre point (x,y), a width, and a height. The origin of the image is defined as the centre of the two eyes at the top of the nose.

In addition to the above, the embodiment of the invention also stores user image data 306, and user image feature area data 308 in the user data area 171 of the hard disk, when the embodiment of the invention is in use. The user image data 306 will usually constitute an input photograph image, which is then processed as described previously in respect of the prior art, to generate a veridical line drawing, which is also stored. The user image feature area data 308 is data which defines feature areas corresponding to the feature areas defined in the reference image, and described above. The derivation of the user image feature area data 308 will be described later, suffice to say at the moment that the data is stored in exactly the same format as for the reference image feature area data 304, that is, for each feature area in the user image data, the coordinates (x, y) of the centre of the feature are stored, together with the width and height dimensions.

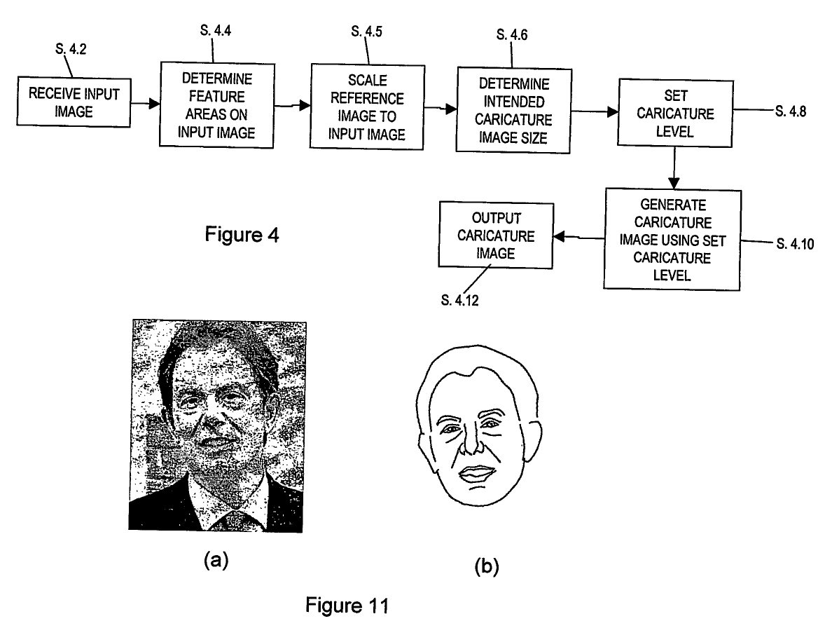

Turning now to FIG. 4, an overview of the operation of the embodiment of the invention and in particular of the three programs described previously will now be undertaken.

Imagine that a user wishes to use the embodiment of the invention to generate a caricature image. Using the general purpose computer 1, the user will use the input devices thereto to first of all start the control and interface program 314 provided by the embodiment of the invention. The control and interface program 314 provides a user interface for the embodiment of the invention, and provides user control buttons and the like in order to allow the user to start the caricaturing process, stop the caricaturing process, and to input images to be used as the basis for a caricatured image to be generated. Therefore, at step 4.2 a user uses the control and interface program 314 in order to input an input image. The input image may be a photograph such as is shown in FIG. 11(a) or FIG. 7(a), or alternatively may be a veridical line drawing such as is shown in FIG. 11(b). The control and interface program 314 then stores the input image in the user image area 306 of the hard disk 168. Additionally, where the input image is a photograph, the control and interface program 314 acts to guide the user to generate a veridical line drawing of the subject in the photograph, which will then be used as the basis for caricaturing later on. The veridical line drawing image is also stored in the user image area 306 of the hard disk.

Therefore, at this point the control and interface program 314 has allowed the user to input an image, and to produce a veridical line drawing of that image if required. The next step is then to define feature areas on the input image, which correspond to the feature areas which are predefined on the reference image, which is stored in the reference image data area 302, and the reference image feature area data area 304 of the hard disk. In order to achieve this, at step 4.4 the control and interface program 314 starts the area determination program 312. The area determination program 312 acts to display the veridical line drawing user image stored in the user image data area 306 to the user, and prompts the user to click on certain points in the image or to trace lines in the image to define the required feature areas thereon. For example, the area determination program 312 will prompt the user to click on points which define the area of the mouth in the line drawing, the respective areas of the left and right eyes, etc. In all, the user is asked to define corresponding areas on the input image to each of the seventeen areas defined in the reference image. The area determination program 312 stores the data obtained by the point clicking procedure in the user image feature area data area 308 of the hard disk 168.

It should be noted here that whilst the inventors have found the user point clicking procedure to provide the most accurate results, the area determination program 312 may, in alternative embodiments, act to determine the feature areas on the input image automatically, using known image processing feature extraction techniques, as shown in FIG. 7(a) and (b). Examples of appropriate feature extraction techniques which may be used are described in Machin DJ: “Real-time Facial Motion Analysis for Virtual Teleconferencing”, IEEE International Conference on Automatic Face and Gesture Recognition (Oct 1996), Proceedings of the Second International Conference on Automatic Face and Gesture Recognition, 14^{th} to 16^{th} October 1996, IEEE Computer Society Press page 340 to 344. Such techniques can operate hierarchically by locating an area “a” for example by reference to easily identifiable features, such as the pupils of the eyes. Then, given such an area “a, this first approximation can be refined by image processing techniques such as edge maps to isolate the feature of interest. In the example shown in FIG. 7(b) the mouth has been located enclosed by area “b”, by processing connected edges in the area “a”. Similar techniques can be used to locate other of the facial features required.

However the feature areas of the input image are determined by the area determination program 312, the next step in the process at step 4.5 is to scale the prototype face of FIG. 6(a) such that the eye separation is that of the input image. The thus scaled reference image is then stored in the reference area 302 on the hard disk 168.

Next, at step 4.6 the control and interface program 314 acts to determine the intended size of the caricature image to be generated. This can be achieved in many ways. For example, the control and interface program 314 may provide an input box or some form of slider control to allow the user to input what size the generated caricature image is to be. Alternatively, the control and interface program 314 may interface with another program, such as, for example, a game program which is using the embodiment of the invention to generate caricatured images for use therein, and may receive input from the other program such as the game program as to what size of caricature image is required.

Having determined the caricature image size, next, at step 4.8 the control and interface program 314 acts to set the required caricature level, in dependence on the intended caricature image size. In the preferred embodiment the caricature level is set as an inverse function of the intended caricature image size, such that the smaller the intended caricature image size, then the higher the caricature level is set. The relationship between the image size and the caricature level need not be linear, and could be defined, for example, by a look-up table or the like. The rationale behind setting a higher caricature level is that it has been determined by prior art workers (see Rhodes, G. & Brennan, S. E. (1987). Identification and Rating of Caricatures: Implications for Mental Representations of Faces. Cognitive Psychology, 19, 473-497) that slight caricaturing of an image of a person can result in enhanced recognisability of that image by another person who views the image. Within the embodiment of the invention, therefore, this basic principle of enhanced recognition is inventively applied by increasing the level of caricaturing dependent on the image size, on the basis that a small image of a person may be more difficult to recognise than a larger image. It should be noted, however, that the invention is not limited to an inverse relationship between caricature level and image size, however, and that the opposite relationship may also be used. That is, in alternative embodiments of the invention, the caricature level may be set at a higher level for a large image, and vice versa.

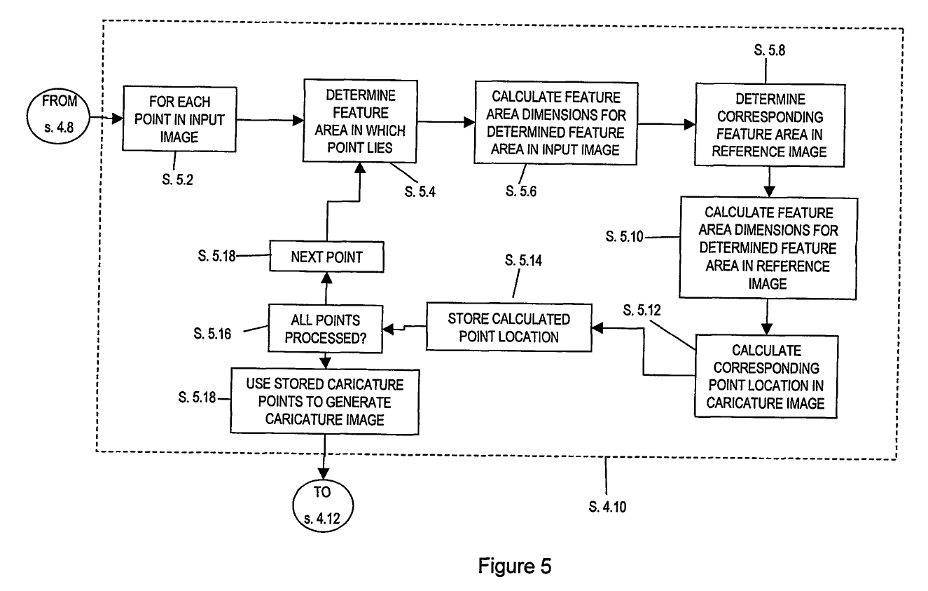

Having set the caricature level at step 4.8 in dependence on the image size, the next step is that the control and interface program 314 launches the caricaturing program 310 at step 4.10, which acts to generate the caricature image using the set caricature level, and using the user image feature area data, and the reference image feature area data. The exact mechanism by which the caricature image is generated will be described later with respect to FIG. 5.

Having generated the caricature image, at step 4.12 the caricaturing program outputs the generated caricature image which the control and interface program 314 then acts to display on the computer screen to the user, if required. Alternatively, the control and interface program 314 may interface with another program such as a game program or the like, and may instead send the output caricatured image to that other program.

The operation of the caricaturing program 317 will now be described in more detail with respect to FIG. 5. Here, having been launched by the control and interface program 314, the first step which the caricaturing program 310 performs is to access the veridical line drawing of the input image, from the user image area 306 on the hard drive 168. Then, for each of the points which were found by the user during the point clicking procedure on the veridical line drawing image, a FOR loop is commenced at step 5.2. Within the FOR loop the first step which is performed at step 5.4 is to determine in which of the seventeen feature areas defined by the user in the image the particular point being processed lies. Having determined this, next, at step 5.6 the feature area dimensions for the determined feature area are calculated or alternatively are read from the user image feature area data store 308, if available. If calculation is required, this is performed by finding those points within the input image which define a bounding box of the feature area, and then calculating the feature area width and height from the coordinates of those points. For example, the width of the feature area is defined by the difference between the x coordinate values of the point within the feature area with the largest x coordinate value and the point within the feature area with the smallest x coordinate value, whereas the height of the featured area is determined in the same way but instead looking at the y coordinate values.

Next, the reference image feature area data 304 is accessed, and the corresponding feature area in the reference image to the feature area in the user image which was determined at step 5.4 is determined at step 5.8. Thus, for example, if step 5.4 determined that the present point being processed lies within the “right eye” feature area of the user image, then step 5.8 will determined that the corresponding feature area is the “right eye” area of the reference image. Then, at step 5.10 the feature area dimensions for the determined feature area in the reference image are calculated, or alternatively read from the reference image feature area data area 304 on the hard disk 168. As described previously, the feature areas are characterised by the coordinate of the centre point thereof, as well as the height and width dimensions.

Having determined the feature area dimensions in which the point lies, and the dimensions of the corresponding feature area in the reference image, it is then possible to calculate at step 5.12 the corresponding point location within the caricature image for the present point being processed in the input image. The calculation is performed as follows.

Within the following, FM is a feature as found on the mean or prototype face, FR is the corresponding feature as found on the real face, and FC is the corresponding feature found on the caricatured face.

Then, for any given point in the real face, Pᵢ^{FR} (i.e. the present point being processed), the corresponding point on the caricature face, Pᵢ^{FC}, can be calculated by the Affine transform given below:

$${P}_{i}^{FC} = [ \begin{matrix}{s}_{x} & 0 & - {C}_{x}^{FR} \cdot {s}_{x} + {C}_{x}^{FR} + {t}_{x} \\ 0 & {s}_{y} & - {C}_{y}^{FR} \cdot {s}_{y} + {C}_{y}^{FR} + {t}_{y} \\ 0 & 0 & 1\end{matrix} ] \cdot {P}_{i}^{FR}$$

$${t}_{x} = a ( {C}_{x}^{FM} - {C}_{x}^{FR} )$$

$${t}_{y} = a ( {C}_{y}^{FM} - {C}_{y}^{FR} )$$

$${s}_{x} = \frac{{FM}_{width}}{{FR}_{width}} \cdot {( \frac{{FR}_{width}}{F {M}_{width}} )}^{1 - a}$$

$${s}_{y} = \frac{F {M}_{height}}{{FR}_{height}} \cdot {( \frac{{FR}_{height}}{F {M}_{height}} )}^{1 - a}$$

Where:
αis the caricaturing level
C^{FM} and C^{FR} are the centres of FM and FR respectively
Similarly

$${C}^{FC} = [ \begin{matrix}{s}_{x} & 0 & {t}_{x} \\ 0 & {s}_{y} & {t}_{y} \\ 0 & 0 & 1\end{matrix} ] \cdot {C}^{FR}$$

Thus, having found the caricature image point location for the present point, the calculated point location is stored at step 5.14 for later use in generating the final caricature image. Then, at step 5.16 an evaluation is performed to determine whether all of the points in the input image have been processed, and if not processing proceeds to step 5.18, wherein the next point is selected. Having selected the next point processing returns to step 5.4, wherein the steps of step 5.4, step 5.6, step 5.8, step 5.10, step 5.12, and step 5.14 are repeated for that next point.

If the evaluation at step 5.16 determines that all of the points in the input image have been processed, then processing proceeds to step 5.18 wherein the stored caricature points are used to generate the final caricature image. As the points define facial features in a line drawing, the generation of the caricature image is performed by plotting the stored calculated point positions on the image map, and then joining up those points which each refer to the same feature area with lines, according to the format of the input line drawing. This results in a line drawing caricature image, which can then be output.

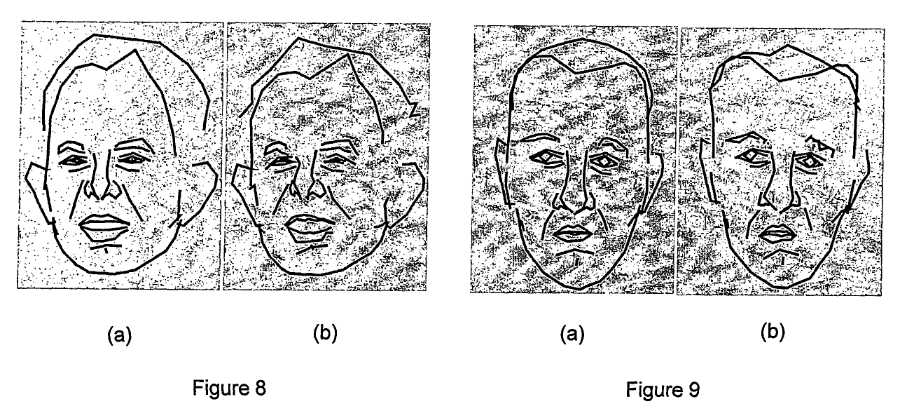

Example line drawing caricatures as generated by the embodiment of the invention are shown in FIG. 8(a) and FIG. 9(a). Corresponding line drawing caricatures as generated by the prior art Brennan algorithm are shown in FIG. 8(b) and FIG. 9(b). From these results it will be seen that the line drawing caricatures generated by the embodiment of the invention do not cause distortions within the features per se of the image, unlike those of the prior art. In particular, in FIG. 8 it will be seen that the prior art algorithm has acted to distort the hairline of the image, as well as the eyebrows (see FIG. 8(b)), whereas this has not been the case in the caricature generated by the embodiment of the present invention (see FIG. 8(a)) wherein the transformations are applied on a feature by feature basis and comprise translation and scaling transformations. Similarly, in FIG. 9(b) it will be seen that the prior art algorithm has acted to distort the right eyebrow, as well as the hair line, and the right ear, whereas the caricature produced by the present invention does not show such artefacts.

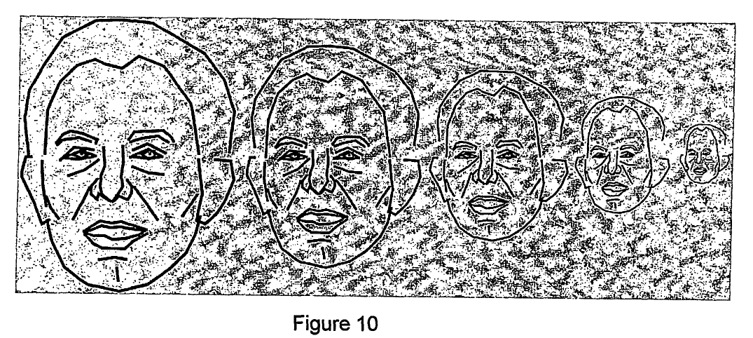

FIG. 10 illustrates the effect of the intended caricature image size on the output of the present invention. Particularly, FIG. 10 illustrates five output caricature images, wherein the caricature level has been increased in an inverse relationship to the caricature size. This will be apparent by considering the smallest caricature image on the right hand side, and comparing the features thereof to the largest caricature image on the left hand side, and which has the least caricature level applied thereto. It will be seen that the smallest caricature image which has had the greatest caricature level applied has more distorted features than that of the largest caricature image but that the smallest caricature image is still recognisable as being an image of the same person as that shown in the largest caricature image.

The above described embodiment calculates caricaturing transformations from an input image and the prototype image, and the transformations are then applied to the input image. However, in a second, more general, embodiment the transformations may be calculated in the same manner, and then applied to a third, different, image to transform that image. More particularly, to caricature a third facial image (FM′), then assuming it is close to the mean face and scaled appropriately (for instance, using eye-separation as described previously), the calculations are as follows.

Within the following, FM is a feature as found on the mean or prototype face, FR is the corresponding feature as found on the real face, FC is the corresponding feature found on the caricatured face, and FM′ is a feature as found on the third, or “target”, face.

Then, for any given point in the real face, Pᵢ^{FR} (i.e. the present point being processed), the corresponding point on the caricature face, Pᵢ^{FC}, can be calculated by the Affine transform given below:

$${P}_{i}^{FC} = [ \begin{matrix}{s}_{x} & 0 & - {C}_{x}^{F M} \cdot {s}_{x} + {C}_{x}^{F M} + {t}_{x} \\ 0 & {s}_{y} & - {C}_{y}^{F M} \cdot {s}_{y} + {C}_{y}^{F M} + {t}_{y} \\ 0 & 0 & 1\end{matrix} ] \cdot {P}_{i}^{F {M}^{′}}$$

$${t}_{x} = {C}_{x}^{FR} - {C}_{x}^{F M} + a ( {C}_{x}^{F M} - {C}_{x}^{FR} )$$

$${t}_{y} = {C}_{y}^{FR} - {C}_{y}^{F M} + a ( {C}_{y}^{F M} - {C}_{y}^{FR} )$$

$${s}_{x} = {( \frac{{FR}_{{}_{width}}}{F {M}_{width}} )}^{1 - a}$$

$${s}_{y} = {( \frac{{FR}_{height}}{F {M}_{height}} )}^{1 - a}$$

Where:
αis the caricaturing level;
C^{FM} and C^{FR} are the centres of FM and FR respectively, and C^{FM′} is the centre of FM′
Similarly

$${C}^{FC} = [ \begin{matrix}{s}_{x} & 0 & {t}_{x} \\ 0 & {s}_{y} & {t}_{y} \\ 0 & 0 & 1\end{matrix} ] \cdot {C}^{F {M}^{′}}$$

Replacement of FM′ with FM gives a general form of the existing equations of the first embodiment—more verbose perhaps, but showing how the mean model may be interchanged. This second embodiment allows the affine transform for each feature to be calculated once and then applied to many models. Apart from the above difference, however, the second embodiment is substantially identical to the first embodiment as previously described.

Whilst in the embodiments described above the caricature images and the input thereto are veridical line drawings, it should be understood that the invention is not limited to generating line drawing caricatures, but that these have been described by best illustrating the invention. In other embodiments of the invention the feature based algorithm described herein can be applied directly to the photo quality image originally input, in which case the user will be asked to define areas on the input image corresponding to the feature areas required by the invention. Then, generation of the caricature image can be performed on a pixel by pixel basis of the original input image, comparing the pixel location with the defined featured areas, and generating a new pixel location in the caricature image. It is envisaged that some blending within and between feature areas within the caricature image will be required in order to account for translation of features within the image. For example, it may be desirable to triangulate the photograph using the corners of each feature box and morph the photo in a manner as described in Benson, P. J., Perrett, D. I., “Synthesizing Continuous-Tone Caricatures”, IVC(9), 1991, pp. 123-129, any necessary features of which required for understanding this point being incorporated herein by reference.

In summary, therefore, the present invention has presented a new caricaturing algorithm which treats image features separately, and applies independent caricaturing at a feature-based level. As has been shown this provides for less distortion in the resulting caricatured image than has previously been the case with the prior art algorithms.

Unless the context clearly requires otherwise, throughout the description and the claims, the words “comprise”, “comprising” and the like are to be construed in an inclusive as opposed to an exclusive or exhaustive sense; that is to say, in the sense of “including, but not limited to”.

Moreover, for the avoidance of doubt, where reference has been given to a prior art document or disclosure, whose contents, whether as a whole or in part thereof, are necessary for the understanding of the operation or implementation of any of the embodiments of the present invention by the intended reader, being a man skilled in the art, then said contents should be taken as being incorporated herein by said reference thereto.

1. A method of generating a caricatured image, comprising the steps of:
receiving an input image to be caricatured;
identifying feature areas on the input image and
applying respective caricaturing transformations to the identified feature areas in the input image so as to generate a caricatured image comprising the transformed feature areas.

2. A method according to claim 1, wherein the caricaturing transformations comprise at least one of a scaling transformation and/or a translation transformation.

3. A method according to claim 1, wherein the applying step further comprises, for a point in the input image, determining in which of the identified feature areas the point lies; and calculating the position which the point should take within the caricatured image as a function of the characteristics of the determined feature area within the input image, or of the characteristics of a corresponding feature area within another image.

4. A method according to claim 3, and further comprising storing a reference image having predefined feature areas, wherein the identifying step further identifies feature areas on the input image or on the other image corresponding to the predefined feature areas on the reference image, and wherein said characteristics comprise one or more ratios of the dimensions of the determined feature area within the input image, or of the corresponding feature area within the other image, to the corresponding feature area in the reference image.

5. A method according to claim 1, and further comprising determining a caricature level defining the amount of caricaturing to be applied to the input image in dependence on the intended size of the caricature image to be generated; and applying the caricaturing transformations in dependence on the determined caricature level.

6. A method according to claim 1, wherein the input image comprises an image of a subject face, the identified feature areas each containing a particular facial feature.

7. A computer program or suite of computer programs arranged such that when executed by a computer system it/they enable the computer system to operate according to claim 1.

8. A computer readable storage medium storing the computer program or one or more of the suite of computer programs according to claim 7.

9. A caricature generation system, comprising:
an image input means for receiving an input image to be caricatured; and
processing means arranged in use to:
i) identify feature areas on the input image; and
ii) apply respective caricaturing transformations to the identified feature areas in the input image so as to generate a caricatured image comprising the transformed feature areas.

10. A system according to claim 9, wherein the caricaturing transformations comprise at least one of a scaling transformation and/or a translation transformation.

11. A system according to claim 9, wherein the processing means is further arranged in use to: for a point in the input image, determine in which of the identified feature areas the point lies; and calculate the position which the point should take within the caricatured image as a function of the characteristics of the determined feature area, or of the characteristics of a corresponding feature area within another image.

12. A system according to claim 11, and further comprising storage means arranged in use to store a reference image and data defining pre-defined feature areas of the reference image, the processing means being further arranged in use to identify feature areas on the input image corresponding to the predefined feature areas on the reference image; wherein said characteristics comprise one or more ratios of the dimensions of the determined feature area within the input image, or of the corresponding feature area within the other image, to the corresponding feature area in the reference image.

13. A system according to claim 9, wherein the processing means is further arranged in use to: i) determine a caricature level defining the amount of caricaturing to be applied to the input image in dependence on the intended size of the caricature image to be generated; and ii) apply the caricaturing transformations dependence on the determined caricature level.

14. A system according to claim 9, wherein the input image comprises an image of a subject face, the identified feature areas each containing a particular facial feature.
